(19) United States
(12) Patent Application Publication
(10) Pub. No.: US 2010/0293565 A1
(43) Pub. Date: Nov. 18, 2010

(54) INTERACTIVE TELEVISION BROADCAST

(75) Inventor: Erkki Rantalainen, Ristiina (FI)

Correspondence Address: BROOKS KUSHMAN P.C., 1000 TOWN CENTER, TWENTY-SECOND FLOOR, SOUTHFIELD, MI, 48075, US

(73) Assignee: SUPPONOR OY, Ristiina (FI)

(21) Appl. No.: 12/669,295

(22) PCT Filed: Jun. 19, 2008
(86) PCT No.: PCT/FI08/50378

§ 371 Date: Apr. 21, 2010

(30) Foreign Application Priority Data
Jul. 17, 2007 (FI) 20070551

(51) Int. Cl. H04N 5/445; H04H 60/33; H04N 7/10

(52) U.S. Cl. 725/13; 725/61; 725/34

(57) ABSTRACT

In the method for providing an interactive television broadcast, an area of interest in a television picture, corresponding to an object of interest shown in the picture and intended to be associated with interactivity, is determined by means of a marking surface arranged in a particular location relative to the object of interest and differing from the marking surface surroundings on the basis of the radiation from it, the marking surface being detected by a detector sensitive to said radiation.

### FIELD OF THE INVENTION

The present invention relates to interactive television broadcasts enabling a television watcher to interact with a television program.

### BACKGROUND OF THE INVENTION

Term Interactive Television covers a vast variety of different aspects. In its simplest meaning, the interactivity can even refer to the television watcher's possibility to select the channel to be viewed. A bit more advanced and nowadays common forms of interactivity are different kinds of votings or competitions where the watchers can participate e.g. by calling or sending a text message with a particular content by a mobile phone to a given number. Known are also systems where the program content shown to the viewer is changed according to the selection by the viewer between two or more program options.

However, perhaps the highest commercial interest in interactive television lies in interactive marketing and advertising. For example, advertisers often would like to provide additional information for those watchers owing special interest in some advertisement or product shown in the television picture. Traditionally, e.g. in a television broadcast from a sports event, a television watcher sees the advertisements placed at the sports event venue. The broader is the coverage of the broadcast the more watchers are able to see the advertisement. In the case of a conventional television broadcast, however, the advertiser has no direct way to gather information about the number of watchers who really have noticed the advertisement. The advertiser has even fewer means to provide additional marketing information for those really interested in the advertisement.

One known solution for providing interactivity in a television broadcast is transmitting along the actual television signal also interactivity triggers synchronised to some period of the program. These triggers may appear to the viewer e.g. as some kind of icon or text indicating that there is possibility for interaction. The viewer, when seeing this kind of trigger, can use, for example, a television remote control handset to activate a pre-determined operation associated to the television program content. This operation can be e.g. showing additional information relating to the content of the interactive period of the television program. The synchronised trigger-based system described above is, however, very inflexible and restricted. It only suits cases where it is clear to what particular object shown in the television picture the interactivity is attached.

A bit more flexible system is described in U.S. Pat. No. 7,367,042 and US 2008066129. In the system proposed in those publications, the area of an object to which additional information is annotated, is determined and a “mask” according to this area generated and transmitted together with the actual television signal. At the receiving portion of the system, this mask highlighting the object is added to the original television picture. This indicates to the viewer the possibility of interaction. The viewer can then notify the receiving portion of the system e.g. by a remote control that the additional information is desired. Also this approach, however, has severe limitations. For example, determination of the area of the object for generating said mask is a complicated and manually operated process. Thus, it suits mainly to cases with a slowly changing content of the television picture and with only one interactive object in the picture at a time.

Thus, there is a great need for a flexible and generic system for attaching interactive functionality to a television broadcast.

### SUMMARY OF THE INVENTION

The present invention is aimed to respond to the need mentioned above. The present invention is characterized by what is presented in claim 1.

The method of the present invention for providing an interactive television broadcast comprises firstly shooting a view comprising an object of interest by a camera; generating, based on the images captured by the camera, a video signal determining a television picture comprising an area of interest according to the object of interest; generating area of interest data determining the size, shape and location of the area of interest; and transmitting the video signal and the area of interest determining data.

The equipment and detailed processes used in the first steps listed above are well known for those skilled in the art and thus do not necessitate any further discussion here. For example, the camera can be an apparatus of any type suitable for capturing images for generating a video signal for producing a television presentation consisting of images, also called frames, sequentially following each other.

Neither the actual forms of the video signal nor the area of interest data are essential from the point of view of the basic principles of the present invention. Alternative ways to generate and transmit them are well known for those skilled in the art. For example, television standards determine several possibilities to attach additional data to a video signal.

The steps of generating and transmitting further the area of interest data serve as a basis for the next steps of the method: receiving the video signal and the area of interest data; displaying the television picture according to the received video signal; providing a feedback link for allowing a television watcher to give a notification of interest concerning the content of the television picture within the area of interest; and performing, in the case of a notification given by the watcher, an additional operation, preferably relating to said content within the area of interest.

The steps above are performed at a receiving stage of the television signal transmission path. The signal transmission path means herein the entire signal transmission path from the camera to a viewing apparatus finally displaying the television picture for the television watcher. The equipment used for these steps can be any equipment suitable for receiving those signals and, based on them, generating and displaying television programs consisting of sequential television pictures. Thus, in addition to a regular television receiver, also a computer and even a mobile phone equipped with suitable television viewing software are possible. Also the feedback link can be arranged in many alternative ways. In the case of a television receiver, a remote control handset is a straightforward choice. Other possibilities are a game console linked to a television receiver, a mouse or keyboard of a computer or the mobile phone push buttons.

The additional operation started as a response to a request given by a television watcher can be of any type. As a typical example, additional content containing further information concerning the original content of the area of interest can be displayed in the television picture. Some examples of other possible additional operations as a part of the interactivity are: in the case of a computer as the viewing apparatus, opening a web page relating to the content of the television picture in the interactivity area; in the case of a mobile phone as the viewing apparatus, sending a request for contact as a text message to a company relating to the content shown in the interactivity area; just sending a one-way notification to an advertiser about an interest shown by the television watcher in order to gather statistics about the interest raised towards an advertisement amongst the television watchers.

According to the present invention, generating the area of interest data comprises: arranging in a particular location relative to the object of interest a marking surface operating as a source for radiation differing from the radiation from its surroundings; shooting the view by a detector responsive to the radiation from the marking surface; and determining the area of interest within the television picture on the basis of said particular location, the location of the marking surface area within the image area of the detector, and the relationship between the image area coordinates of the camera and the detector.

The particular location of the marking surface can lie within the area of the object of interest or in the vicinity thereof. The radiation of the marking surface can be e.g. infrared radiation. The detector can be arranged to shoot the view through a separate optical path or using optics common with the camera. When the particular location in the surroundings shot by the camera and the coordinate relationship between the image areas of the detector and the camera are known, it is straightforward to determine the coordinates of the area of interest within the television picture. In contrast to, for example, the system disclosed in U.S. Pat. No. 7,367,042 and US 2008066129, the area of interest determination can be performed automatically, rapidly and accurately with suitable software without any need for manual signal processing, which is a great advantage. The way of generating the area of interest data according to the present invention also provides a very flexible starting point for further steps of attaching interactive operations to the areas of interest. The preferable embodiments of the present invention are described in the following.

For facilitating the adaption of the additional operation according to the content of the area of interest, in a preferred embodiment of the present invention, identification data identifying the content of the area of interest is generated and transmitted along with the video signal and the area of interest determining data.

In a preferred embodiment of the present invention, based on the area of interest data, substitutive content is inserted to the area of interest, and the identification data is updated accordingly. The insertion of substitutive content can be used e.g. to change an advertisement billboard area visible in the television picture. The reason for the substitution can be e.g. the local circumstances, customer preferences, or legislation. When transmitting also the updated identification data further together with the video signal modified by the insertion of substitutive content, the additional operation can be adapted properly. Naturally, by means of the area of interest data, substitutive content can be inserted to the television picture also at the receiving stage of the signal transmission path.

In order to improve the usability of the interactive interface between the television program and a television watcher at the receiving stage of the signal transmission path, an interactivity-indicating visual effect is preferably inserted to the television picture in connection with the area of interest according to the area of interest data. The essential point here, enabled by the area of interest data received, is that this insertion is carried out at the receiving stage, i.e. at e.g. the device receiving the video signal and preparing the program to be displayed. Thus, no selections concerning the receiving device type need to be made at the earlier stages of the signal transmission path. In other words, from the transmitting point of view, the receiving device type has no meaning, which makes the process very flexible. The effect itself can be e.g. some text or icon placed in some particular location relative to the area of interest and indicating the possibility to interaction. It can also be an area where the image content is modified, e.g. darkened or re-coloured, the area surrounding or covering at least partially the area of interest. Naturally, particularly in the case of only one area of interest in a frame, no particular interactivity indicator is necessarily needed.

In a preferred embodiment of the present invention, the marking surface is adapted to cover the area of the object of interest within the camera field of view. The area of the object of interest within the camera field of view is that portion of the object of interest which, in the case of no obstacles between the camera and the object, is visible to the camera. In addition to an accurate determination of the area of interest, this embodiment also enables determining whether there are visual obstructions between the camera and the object of interest. In other words, for example, a person standing in front of the object of interest can hide part of the object of interest so that it is not visible in an image captured by the camera. This hidden part can be evaluated based on the shape of the marking surface area in the detector image. This information of possible hidden areas can be utilised, for example, when inserting substitutive content to or adding an interactivity-indicating visual effect to the area of interest. Using the information about the visual obstruction allows adapting the substitutive content or the visual effect only to the visible portion of the object of interest. This kind of determination of the possibly hidden areas as such is described in more detail e.g. in the applicant's earlier patent application WO 01/58147.

In a preferred embodiment of the present invention, the object of interest is an advertising billboard. According to this embodiment, e.g. in television broadcast from a sports event, it is possible to attach interactive advertising operations to the television broadcast linked to the area of the billboard within the television picture. There are different ways to arrange the interactivity operation. For example, information about the company or product relating to the advertisement can be transmitted as the identification data described above along the actual video signal. Then, at the receiving stage of the signal transmission path, the additional operation can be adapted according to this information.

In one preferred embodiment of the present invention, several marking surfaces are used to determine several areas of interest within a single television picture. The basic principles concerning generating the area of interest data provide a very efficient way to incorporate several interactivity areas in a single frame. This further emphasizes the advantageousness of the present invention. Naturally, in the case of several simultaneous interactivity areas, the watcher has to be given means to identify which one of them he or she means when giving the notification of interest. Identification can be based on e.g. using different highlighting effects. In the case of using a computer, mobile phone or the like as the displaying device, identifying is straightforward using a mouse or other corresponding pointing equipment. In the case of a regular television, e.g. different colours according to the coloured buttons of a remote control handset can be used. Technology relating to the selection is not in the core of the present invention and designing the details is of routine work for a person skilled in the art.

Though disclosed in separate claims, the preferable features of the present invention described above can be present in a method according to the present invention, simultaneously and in any combination.

### BRIEF DESCRIPTION OF THE DRAWINGS

The present invention will be described in more detail in the following by means of the accompanying figures illustrating one preferred embodiment of the present invention.

FIG. 1 illustrates the principle of generating the original video signal and determining the interactivity areas within the final television picture.

FIGS. 2 and 3 represent, schematically, the actual signals and operations performed in the method.

### DETAILED DESCRIPTION OF THE INVENTION

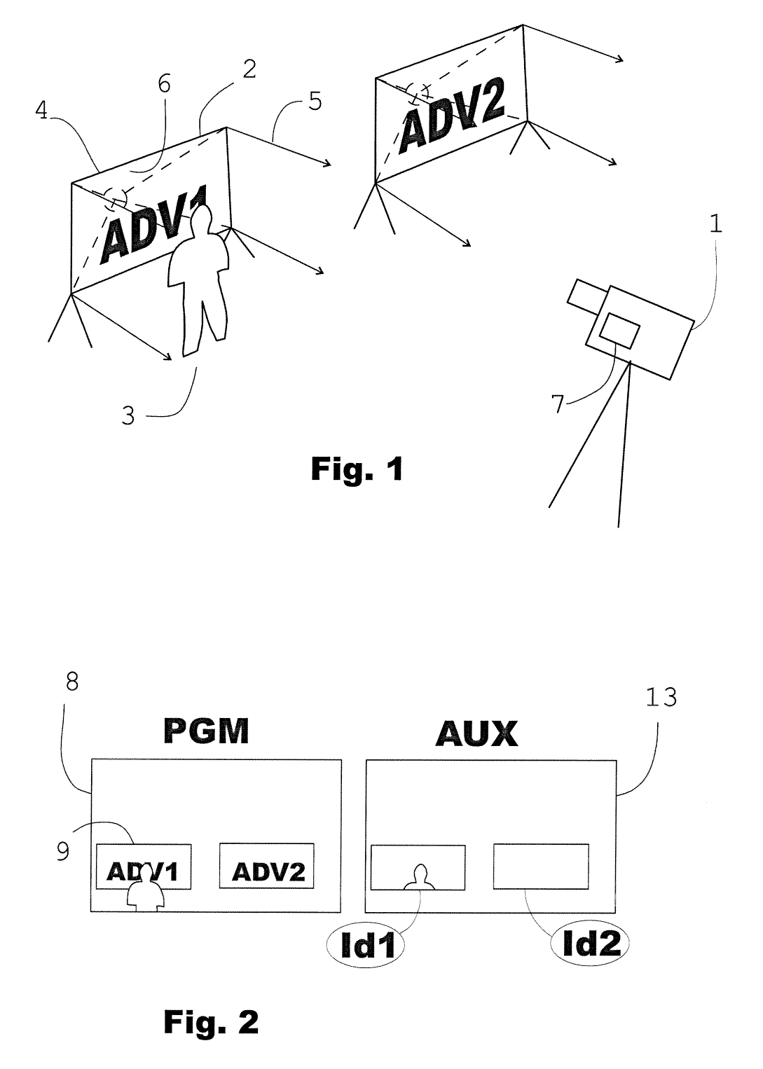

FIG. 1 illustrates the starting point of the exemplary embodiment of the present invention. A video camera 1 shoots a view including advertising billboards 2. Interactivity is intended to be attached to the areas of the billboards in the final television picture. Between the video camera and one of the billboards, there is a person 3 making a part of that billboard invisible to the video camera. For marking the areas of the billboards in the image captured by the video camera and thus for getting information needed for determining the areas of them in the television picture, i.e. the areas to be equipped with interactivity, there is an infrared radiation source 4 behind each of the billboards, emitting infrared radiation 5 to the whole area of the billboard. Naturally, the radiation could be any type of radiation sufficiently differing from the other radiation at the venue. The billboards are arranged to re-direct this radiation to the front side of the billboards. Thus, to the direction of the video camera, the billboard surfaces 6 appear as planar infrared sources. The infrared radiation from the billboard areas is detected by a special detector 7 attached to the video camera.

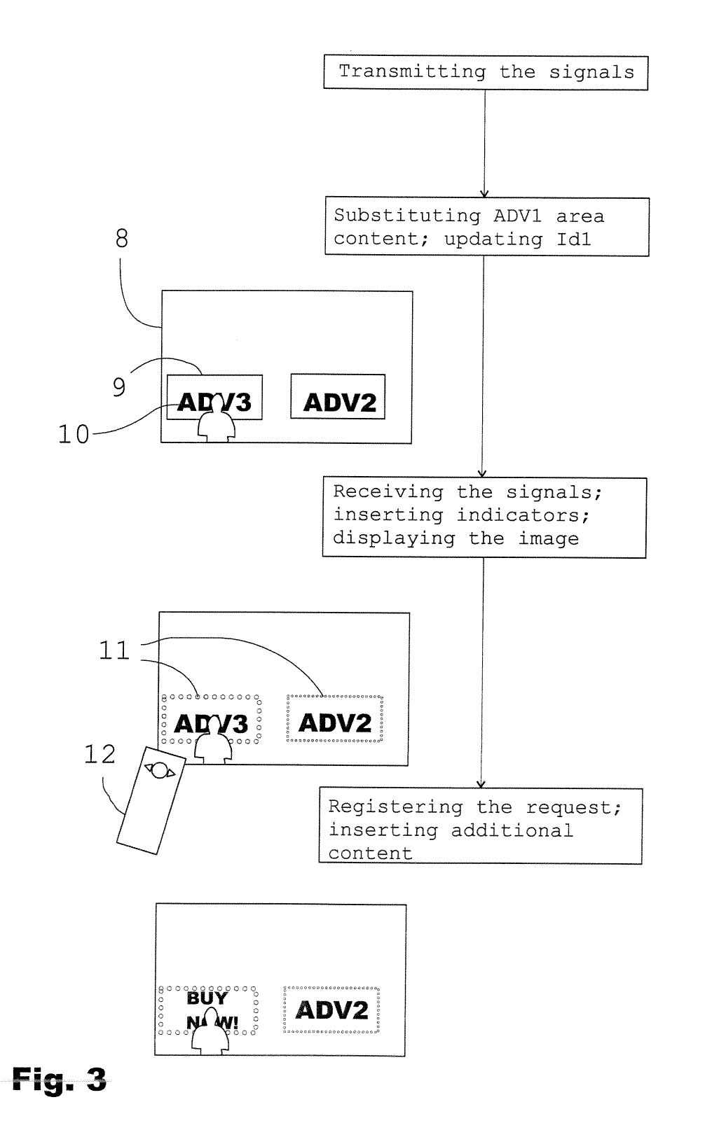

The images captured by the video camera form a video signal PGM, a television picture 8 based on it being shown in FIG. 2. The picture shows the appearance of the billboards, one of them being partly hidden by the person 3 standing in front of it.

From the data captured by the detector, when the relationship between the coordinates of the detector and video camera image areas is known, it is possible to determine the areas of interest in the television picture. Further, it is possible to determine the portion of the one of the billboards behind the person 3 and thus not visible to the video camera. In the embodiment at issue, these are combined to form an auxiliary image signal AUX determining the locations, shapes and sizes of the billboard areas visible in the image captured by the video camera. An image 13 according to the auxiliary image signal, showing the determined billboard areas, is also presented in FIG. 2. At the stage of preparing the signals to be transmitted further, also identification data Id1, Id2 identifying the contents of the billboard areas in the television picture are prepared. Identification data can comprise, for example, names of the products and companies relating to the advertisements.

In the process illustrated in FIG. 3, the auxiliary image signal AUX and the identification data Id1, Id2 are transmitted along the actual video signal PGM. In this example, at a later stage of the signal transmission path, the content of the partially hidden advertising billboard area in the television picture 8 is replaced by a substitutive advertisement 10. This kind of replacement can be used for adaptive advertising, i.e. showing different advertisement in different broadcast receiving areas. One but in no way limiting example of a situation where this is needed is prohibition of advertising of tobacco or alcohol by the legislation in some of the receiving countries. Based on the auxiliary image signal, the insertion of substitutive content can be performed effectively and accurately without any need for e.g. time-consuming and inaccurate manual determination of the area of interest. In addition, also the hidden portion of the billboard can be taken into account in the insertion of substitutive content. Due to the substitution, also the identification data Id1 is updated, according to the substitutive content, before transmitting it further with the video and auxiliary signals.

Finally, at a receiving stage of the signal transmission path, when preparing the final television picture 8 to be displayed, highlighting borders 11 indicating to the watcher the interaction possibility are added to the billboard areas 9 according to the billboard area location information contained in the auxiliary signal. In this example, as shown in FIG. 3, two borders of different thicknesses are used in order to distinguish between the two advertisements. The selected one of the two advertisements has a wider border. Naturally, also any other identifier utilising e.g. different colours could be used.

In this exemplary embodiment at issue, selecting between the two advertisements as well as giving to the viewing apparatus a request to activate the interactive operation attached to selected advertisement can be made by a remote control handset 12.

In this example, as shown in FIG. 3, the additional operation comprises showing in the television picture 8, in the area of the selected advertisement, additional information relating to said advertisement. This additional information can be attached to the transmitted signals already at an earlier stage of the signal transmission path or it can be stored in the memory of the viewing apparatus from where it is selected according to the identifying data Id1 received together with the video and auxiliary signals PGM, AUX.

The television pictures of FIGS. 2 and 3 represent a single frame of the video signal only. Naturally, the described operations are performed to all frames and pictures thereof where content substitution and/or interactivity incorporation is to be performed. For example, a highlighting border or other type of interactivity indication is naturally adapted to be shown the time the interactivity is intended to be provided. Based on the frame by frame determined interactivity areas according to the marking surfaces, using these kinds of indicators is very easy and accurate irrespective of the number of simultaneously shown interactivity areas or the possibly rapid changes in their appearance in the television picture e.g. in the case of a television broadcast from a sports event.

It is important to keep in mind that the process illustrated in FIGS. 1 to 3 and described above is one simplified and exemplary embodiment of the present invention only. The actual signal types and the ways of transmission needed in the method can vary freely within the scope of the claims. It is also possible to carry the additional information determining the interactivity areas within the television picture in the same signal with the video image. As is known for a person skilled in the art, television standards determine initially empty data blocks suitable for this purpose. Moreover, the present invention is not limited to any specific equipment. All of the above-described steps of processing the signals can be performed automatically, in a computer-controlled manner by standard or by application-specific equipment or as well by adjusting the signals at least partially manually.

1. A method for providing data for an interactive television broadcast, the method comprising;
shooting a view comprising an object of interest by a camera;
generating, based on the images captured by the camera, a video signal (PGM) determining a television picture comprising an area of interest according to the object of interest;
generating area of interest data (AUX) determining the size, shape and location of the area of interest;
transmitting the video signal (PGM) and the area of interest data (AUX); and
characterised in that generating the area of interest data (AUX) comprises;
arranging in a particular location relative to the object of interest a marking surface operating as a source of radiation differing from the radiation from its surroundings;
shooting the view by a detector responsive to the radiation from the marking surface;
determining the area of interest within the television picture on the basis of said particular location, the location of the marking surface area within the image area of the detector, and the relationship between the image area coordinates of the camera and the detector.

2. A method according to claim 1, characterised in that identification data (Id1) identifying the content of the area of interest is generated and transmitted along with the video signal (PGM) and the area of interest data (AUX).

3. (canceled)

4. (canceled)

5. A method according to claim 1, characterised in that the marking surface is adapted to cover the area of the object of interest within the camera field of view.

6. A method according to claim 1, characterised in that the object of interest is an advertising billboard.

7. A method according to claim 1, characterised in that several marking surfaces are used to determine several areas of interest within a single television picture.

8. A method for providing an interactive television broadcast, characterised in that the method comprises;
receiving the video signal (PGM) and the area of interest determining data (AUX) according to claim 1;
displaying the television picture according to the received video signal (PGM);
providing a feedback link for allowing a television watcher to give a notification of interest concerning the content of the television picture within the area of interest; and
performing, in the case of a notification of interest given, an additional operation.

9. A method according to claim 8, characterized in that at the receiving stage of the signal transmission path, an interactivity-indicating visual effect is inserted to the television picture in connection with the area of interest according to the area of interest data (AUX).

10. A method according to claim 1, characterised in that, based on the area of interest data (AUX), substitutive content is inserted to the area of interest, and the identification data (Id1) is updated accordingly.
